(19) United States
(12) Patent Application Publication
(10) Pub. No.: US 2012/0309610 A1
(43) Pub. Date: Dec. 6, 2012

(54) Multi-Component and Layered Formulations for Enhanced Selective Catalytic Reduction Activity

(75) Inventors: Michael P. Harold, Houston, TX (US); Pranit Metkar, Houston, TX (US)

(73) Assignee: UNIVERSITY OF HOUSTON SYSTEM, Houston, TX (US)

(21) Appl. No.: 13/487,987

(22) Filed: Jun. 4, 2012

Related U.S. Application Data
(60) Provisional application No. 61/492,557, filed on Jun. 2, 2011.

(51) Int. Cl. B01J 35/02; B01J 29/04; B01J 35/04; B01J 37/08; B01J 23/72

(52) U.S. Cl. 502/74; 502/100; 502/345; 502/60

(57) ABSTRACT

A method for controlling NOx emissions, in certain instances from diesel or fixed position combustion engines. More specifically a method for forming emission control catalyst structures for fuel combustion, a method of producing the catalyst, and a method of operating the catalyst to control emissions.

### CROSS-REFERENCES TO RELATED APPLICATIONS

This application claims benefit under to the filing sate of U.S. provisional application No. 61/492,557 filed Jun. 2, 2011, entitled “Multi-Component and Layered Formulations for Enhanced Selective Catalytic Reduction Activity” which is hereby incorporated herein by reference in its entirety for all purposes.

### STATEMENT REGARDING FEDERALLY SPONSORED RESEARCH OR DEVELOPMENT

The U.S. Government has a paid-up license in this disclosure and the rights in limited circumstances to require the patent owners to license others on reasonable terms as provided for by the terms of grant No. DE-EE0000205 awarded by the U.S. Department of Energy.

### BACKGROUND

Diesel engine vehicles are highly efficient and economical in terms of fuel consumption compared to gasoline engines. However, the combustion is carried out in excess oxygen resulting in the production of NOx in the exhaust containing a large fraction of un-reacted oxygen. NOx is a mixture of NO and NO₂ of which NO comprises a major fraction in untreated vehicle exhaust (NO/NOx>0.90). NOx is a primary precursor of ground-level ozone, a component of smog that is highly detrimental to human beings, in exasperation respiratory diseases like asthma and in causing irreversible lung damage. NOx also participates in the formation of particulate matter (PM) in the atmosphere, another pollutant harmful to the respiratory system. Because of these and many other detrimental effects of NOx on the environment, EPA standards for NOx emissions are increasingly stringent, especially in EPA ozone non-attainment areas. In order to meet the EPA standards, various techniques such as NOx storage and reduction (NSR) and selective catalytic reduction (SCR) of NOx are being widely researched and developed to eliminate NOx from the exhaust of lean-burn vehicles.

The selective catalytic reduction of NOx using NH₃ as a reductant is considered by some to be the most promising technology for lean NOx reduction. In vehicle applications, NH₃ is generated by the thermal decomposition of urea supplied on-board. Although NH₃-based SCR has been known for decades for stationary source (e.g. power plants) applications, it was only commercialized for diesel engine vehicles in the last decade. Various catalysts are being widely researched and used commercially for this purpose. Vanadium-based catalysts (e.g. V₂O₅/TiO₂/WO₃) are the most commonly used catalysts for SCR. However, these catalysts are not sufficiently durable at higher temperatures and suffer activity loss. There is also concern about the release of vanadia, a known toxin, into the environment.

Thus, the industry focus has shifted to Fe- and Cu-based zeolite catalysts to improve NOx reduction efficiency over a relatively broad temperature range. These catalysts show improved high temperature stability, especially Cu-chabazite (SSZ-13) and Cu-SAPO-34. Further, Cu-based catalysts demonstrate high NOx reduction activity at lower temperatures (≦350° C.) and some forms are found to be less sensitive to the amount of feed NO₂ at lower temperatures. Fe-based catalysts are active at higher temperatures (>350° C.), with high NOx reduction efficiencies at very high temperatures (up to 600-700° C.). Unlike Cu-zeolite, the presence of feed NO₂ enhances the NOx conversion efficiency of Fe-zeolite catalyst at lower temperatures.

The chemistry of various SCR reactions is summarized below. The selective catalytic reduction reactions are mainly divided into the following three categories.

Standard SCR Reaction.

This reaction involves NO and NH₃ reacting in presence of O₂:

4NH₃+4NO+O₂→4N₂+6H₂O ΔH=−4.07×10⁵ J/mol NH₃ (1)

Fast SCR Reaction.

This reaction is called “fast SCR” reaction because it is much faster than the standard SCR reaction shown in Eq. (1). Additionally, it has both NO and NO₂ in the feed reacting simultaneously with NH₃:

2NH₃+NO+NO₂→2N₂+3H₂O ΔH=−3.78×10⁵ J/mol NH₃ (2)

NO₂ SCR Reaction.

For this reaction, the feed NOx consists of only NO₂ reacting with NH₃ and is given by:

4NH₃+3NO₂→3.5N₂+6H₂O ΔH=−3.41×10⁵ J/mol NH₃ (3)

In addition to these main reactions, some side reactions like NH₃ oxidation take place. Both Fe- and Cu-zeolite catalysts are known to oxidize NH₃ selectively to N₂:

4NH₃+3O₂→2N₂+6H₂O ΔH=−3.12×10⁵ J/mol NH₃ (4)

Ammonia oxidation is undesired because it consumes the reductant needed to react with NOx. Other side reactions like NO oxidation, ammonium nitrate (NH₄NO₃) formation and its decomposition to N₂O also take place on these catalysts. The formation of N₂O (“laughing gas”), while not considered a component of NOx, and comparatively less toxic than NO and NO₂, is undesirable since N₂O is toxic in high concentrations and is a potent greenhouse gas.

While Cu-zeolites are very good low temperature SCR catalysts, at higher temperatures (>350° C.) NOx conversions drop, because of the more pronounced NH₃ oxidation activity. However, NH₃ oxidation is less pronounced on Fe-zeolite and commences at higher temperatures. Conventionally, the combined Fe- and Cu-zeolite catalyst system has not been favored or extensively explored. Various combinations of Fe-zeolite, Cu-zeolite and V₂O₅/WO₃—TiO₂ have been researched and found that Fe-zeolite (brick) followed by Cu-zeolite (brick) (in series) gives higher NOx conversion efficiencies than Cu- or Fe-based catalysts alone. Additionally, the series combinations of (33%) Fe-zeolite followed by (67%) Cu-zeolite delivers an optimum NOx reduction efficiency throughout the temperature range.

Apart from the series combinations of catalysts, alternate catalyst configurations and multiple catalyst combinations to improve catalyst efficiency for various catalytic reactions are being tested in the industry. To date, research has been shown that a physical mixture of zeolites with Na-rich Fe—Cu Fischer-Tropsch catalysts improve activity for the hydrogenation of the carbon dioxide reaction. Additionally, double layer monolithic catalysts (Pt/Al₂O₃ or Pt/SiO₂ as bottom layer, H- or Cu-zeolite (ferrierite or ZSM-5 as top layer) have been used for SCR of NOx with hydrocarbons (e.g., propene) as reducing agents. By using a double layer catalyst the configuration utilizes the precious metal (e.g., Pt/Pd) in the bottom layer to oxidize NO to NO₂ which then diffuses back to get reduced by hydrocarbons (e.g. propylene) in the upper layer containing zeolites. Double-layer catalysts have also been investigated for low temperature NH₃ oxidation to reduce “ammonia slip” from the SCR catalysts. While double layer catalysts were found to be improved for NOx reduction compared to single layered catalysts (e.g., Pt/SiO₂), there is no research into utilizing similar catalyst combinations for the SCR of NOx using NH₃ as a reductant.

Thus, there is a need for an industrially applicable catalyst with high conversion of NOx over both low and high temperature ranges.

### SUMMARY

Generally, the present disclosure relates to new compositions of matter and new processes and methods for the fabrication of a novel class of catalytic materials particularly suitable for the selective catalytic reduction (SCR) of nitrogen oxides (NOx) using ammonia as the reducing agent. More specifically, the present disclosure makes use of two or more catalytic metals supported by a mixture of a shape-selective materials (such as zeolites) that are assembled in a layer-like fashion which results in nonlinear improvement in the overall activity over a wide range of temperatures. This disclosure finds applications particularly as emission control technology for diesel and lean burn gasoline vehicles, and also as a candidate for the replacement of existing vanadia-based catalysts used for NOx reduction applications in various industries that involve combustion processes that produce NOx.

The current disclosure relates to the conception, synthesis, design, fabrication, and testing of a novel class of catalytic materials involving the use of two or more catalytic metals supported by a mixture of a shape-selective material (zeolites) that are layered on top of each other in order to foam a multilayered catalyst supported by a monolithic substrate. This allows an expansion of the temperature range over which high catalytic conversion is maintained, particularly in the case of the selective catalytic reduction of NOx (using ammonia as reducing agent). The present disclosure includes the choice of chemical composition and the layering order of the multi-layered structure containing the catalytic metals/zeolite matrices, which leads to a nonlinear improvement in the overall catalytic activity of the fabricated multilayered systems. This concept may be expanded to include catalysts that contain two or more sections of monolith pieces, each of which may contain multiple films of different thicknesses and compositions. In addition, the concept may include axial profiling of one or more catalytic materials in discrete zones of varied lengths or as films of varied thickness. While this disclosure considers the selective catalytic reduction as the reaction system of interest, the disclosure is applicable to a broader class of reaction systems involving two or more overall chemical reactions.

According to one configuration of the present disclosure, a method of producing a catalyst, comprises milling a catalyst slurry to form particles, washcoating a support with the catalyst slurry to form a coated support, removing excess slurry from the coated support, drying the coated support, and repeating the previous steps. After any number of repeats of the previous steps, the method continues with calcining the multi-layer catalyst. Additionally, the step of washcoating the support further comprises forming a plurality of catalyst composition segments.

According to another configuration disclosed herein there is formed a structure comprising, a monolithic support or a structured foam support, at least one first catalyst segment, and at least one second catalyst segment. In instances the monolithic support or structured foam support comprises ceramic or metallic materials.

According to another exemplary configuration, there is a catalyst composition for selective catalytic reduction (SCR) of NOx, comprising a monolithic support or structured foam support having channels therethrough, a first catalytic segment, and a second catalytic segment.

Thus, embodiments described herein comprise a combination of features and characteristics intended to address various shortcomings associated with certain prior devices. The various features and characteristics described above, as well as other features, will be readily apparent to those skilled in the art upon reading the following detailed description of the preferred embodiments, and by referring to the accompanying drawings.

### BRIEF DESCRIPTION OF THE FIGURES

For a detailed description of exemplary embodiments of the disclosure, reference will now be made to the accompanying drawings in which:

FIG. 1 illustrates a table of exemplary catalysts according to some chemical compositions described herein.

FIG. 2 illustrates a schematic of an exemplary method to prepare multilayer catalysts for SCR according to the disclosure.

FIG. 3 illustrates a graphical comparison of the steady state NH₃ conversions obtained for the NH₃ oxidation reaction studied on commercial catalysts that are made of either single-layer Cu-zeolite (catalyst A) or Fe-zeolite (catalyst B) supported by a monolithic substrate.

FIG. 4 illustrates a graphical comparison of the steady state NOx conversions obtained during the standard SCR reaction studied on commercial single-layer Cu-zeolite catalyst (catalyst A) supported by a monolithic substrate, with two different axial lengths of 1 and 2 cm.

FIG. 5 illustrates a graphical comparison of the steady state NOx conversions obtained during the standard SCR reaction studied on commercial single-layer Fe-zeolite catalyst (catalyst B) supported by a monolithic substrate, with different axial lengths in the range of 0.4 cm to 2 cm.

FIG. 6 illustrates a graphical comparison of the steady state NOx conversions obtained during the standard SCR reaction studied on single-layer catalyst A, single-layer catalyst B, and a series arrangement with catalyst A (1 cm Cu brick) followed by catalyst B (1 cm Fe brick), both supported by a monolithic substrate.

FIG. 7 illustrates a graphical comparison of the steady state NOx conversions obtained during the standard SCR reaction studied on various catalyst containing separate monolith bricks of single-layer catalyst A and single-layer catalyst B in the following order: catalyst B (1.33 cm, 1 cm and 0.67 cm bricks) followed by catalyst A (0.67 cm, 1 cm and 1.33 cm bricks), both supported by a monolithic substrate.

FIG. 8 illustrates a graphical comparison of the steady state NOx conversions obtained during the standard SCR reaction studied on various lab-synthesized single-layer E and F catalysts and mixed single layer G catalyst supported by a monolithic substrate.

FIG. 9 illustrates a graphical comparison of the steady state NOx conversions obtained during the standard SCR reaction studied on various synthesized single-layer E and F catalysts and dual-layer H catalyst supported by a monolithic substrate.

FIG. 10 illustrates a graphical comparison of the steady state NOx conversions obtained during the standard SCR reaction studied on various synthesized single-layer E and F catalysts, and two-layer I, J and K catalysts, supported by a monolithic substrate.

FIG. 11 illustrates of graphical comparison of the steady state NOx conversions obtained during the standard SCR reaction studied on various synthesized single-layer E and F catalysts, and two-layer L and M catalysts (see Table 1 for their chemical composition) supported by a monolithic substrate.

FIG. 12 illustrates a graphical comparison of the steady state NOx conversions obtained during the standard SCR reaction studied on various catalysts including single-layer A, single-layer B, two-layer C and two-layer D (see Table 1 for their chemical composition) supported by a monolithic substrate. Additional plots for the series arrangements of catalysts A and B are also shown. T

FIG. 13 illustrates a graphical comparison of the steady state NOx conversions obtained during the fast SCR reaction studied on various catalysts including single-layer A, single-layer F and two-layer K as found in supported by monolithic substrate.

### NOTATION AND NOMENCLATURE

In the following discussion and in the claims, the terms “including” and “comprising” are used in an open-ended fashion, and thus should be interpreted to mean “including, but not limited to.”.

Directional reference such as “up” or “down” will be made for purposes of description and claims with “up”, “upper”, “upwardly” or “upstream” meaning toward the source of an exhaust or gas flow and with “down”, “lower”, “downwardly” or “downstream” meaning toward the terminal end of an exhaust gas flow or exhaust gas system. As may be understood in certain instances the “lower” or “downstream” portion may have include a vertical elevation from the “upper” or “upstream” portion of the system.

Unless otherwise specified, any use of any form of the terms “connect”, “engage”, “couple”, “attach”, or any other term describing an interaction between elements or components is not meant to limit the interaction to direct interaction between the elements or components and may also include indirect interaction between the elements or components described. Thus, if a first device couples to a second device, that connection may be through a direct connection, or through an indirect connection accomplished via other intermediate devices, apparatuses, and connections.

As used herein, the terms “axial” and “axially” generally mean along or parallel to a given axis of any assembly, exhaust system, or other conduit for gases disclosed herein, regardless of directional orientation. Further, the terms “axial” and “axially” will refer to the central axis of any apparatus positioned within and extending generally along the gas flow axis. As such, an axial distance refers to a distance measured along or parallel to the axis of the gas flow and apparatuses therein.

The disclosure relates to “NOx” and, as used herein, refers to generically to the mixture of mono-nitrogen oxides. Generally, NOx is a mixture of nitric oxide (NO) and nitrogen dioxide (NO₂).

The term “brick” as used herein generally refers to a single piece of catalyst comprising a support and one or more catalyst layer(s). Additionally, brick may refer to a single piece of catalyst having a plurality of segments having one or more different, discreet, catalyst layer(s) disposed there on, or the unitary structure of a plurality of smaller catalyst sections.

As used herein for this disclosure, the term “support” refers to the solid material on which the catalyst is deposited; typically a monolithic or structured foam support defined herein below.

Herein the term “monolith” refers to a solid material serving as the support of catalyst, comprising many parallel or axially oriented channels, the walls of which are coated with catalyst. Generally, the term refers to a single portion or discrete structure.

“Structured foam” herein refers to another type of solid material that serves as the support of catalyst comprising a porous structure having circuitous, torturous, or other non-linear passages or pores for the passage of a gas or gaseous composition therethrough

In the following discussion and claims, the term “washcoat” or “wash coat” refers to a layer of catalytic material deposited/coated on the surfaces of a support as previously defined. Further, the terms “washcoating” or “wash coating” refers to the process of depositing/coating the surfaces of a support.

Certain terms as used are to be interpreted only by the definition provided herein, rather than certain technical or informal usages. For example, the term “ceramic(s)” as used herein generally refer to inorganic solids, having an at least partially crystalline structure. Further “ceramic(s)” include nonmetallic solids, oxides, non-oxides, and composite materials, including materials having combinations of the above and particulate or fiber reinforcing materials. Also, the term “alumina” refers to the aluminum oxide ceramic, as defined herein. The term “zeolite,” as used herein, refers to any microporous matter, generally comprising an aluminosilicate composition, and still more generally having a silica-alumina oxide (Si/Al) ratio of between about 10 and infinity (i.e. pure silica). The “zeolite” may be any shape-selective material and may be used in a ceramic, with a ceramic material, or independent of a ceramic in any composition or mixture.

Unless otherwise described and defined herein, the term “space velocity” refers to the ratio of volumetric gas flow rate, for example at a volume per hour, and at a defined standard total pressure and temperature; herein and usually 1 atmosphere and 298.15 Kelvins, to total geometric volume of the catalyst piece. Furthermore, the term alternatively is referred to as “gas hourly space velocity” or “GHSV” with units of “per hour” (i.e. 1/hr).

### DETAILED DESCRIPTION OF THE DISCLOSED EMBODIMENTS

The present disclosure relates to new compositions of matter and new processes and methods for the fabrication of a novel class of catalytic materials particularly suitable for the selective catalytic reduction (SCR) of nitrogen oxides (NOx). More specifically, the present disclosure makes use of two or more catalytic metals supported by a mixture of a shape-selective material, such as zeolites, that are assembled in a layer-like fashion which conveys nonlinear improvement on the overall activity over a wide range of temperatures, while maintaining a low level of ammonia oxidation that involve combustion processes that produce NOx. The overall catalyst may consist of one or more individual monolith sections (“bricks”), each of which has a unique combination of said layers.

More specifically, this disclosure relates to catalyst designs for minimizing the emissions of harmful pollutants like NOx from diesel engine vehicles and lean burn gasoline engines, as well as stationary power plant applications. The disclosed catalyst system is configured to enhance the NOx reduction performance over a wide temperature range, wherein the catalysts are arranged on the same monolithic structure based on the difference between selectivity and activity as a function of temperature. The overall NOx reduction process comprises of various steps which include the injection of the reductant NH₃ in the form of urea which is decomposed at high temperature (>100° C.), and passing the exhaust gas through the catalyst where the NOx is reduced at lower temperatures by the more active Cu-zeolite layer at the bottom and more selective Fe-zeolite layer at the top at higher temperatures.

Background:

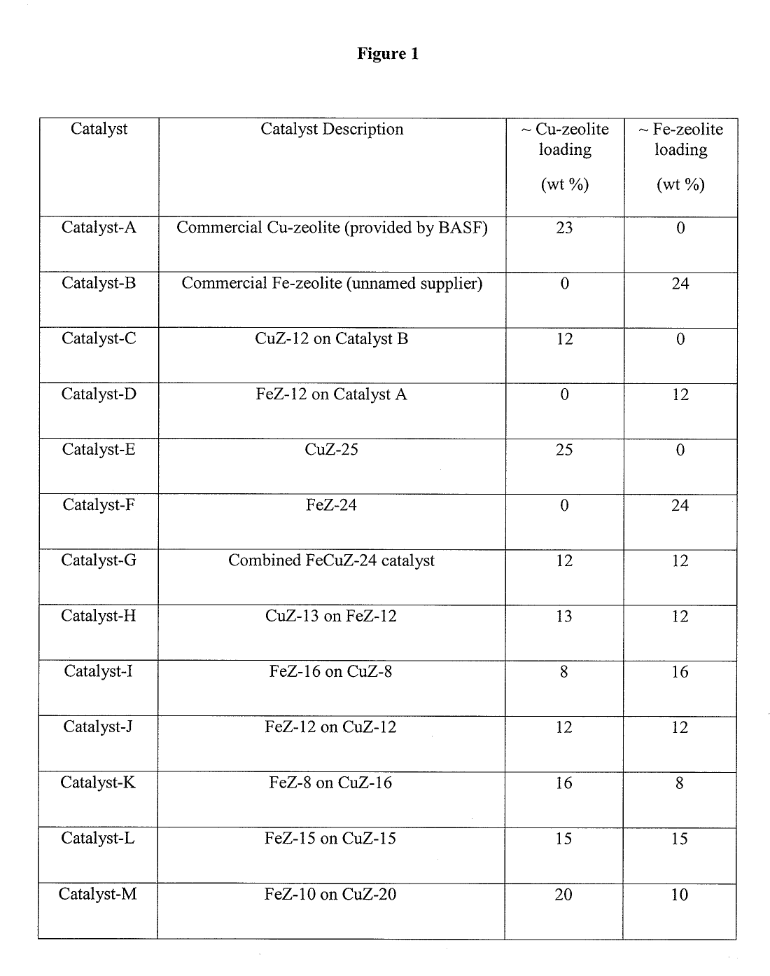

Referring now to FIG. 1, in order to demonstrate the present disclosure, there is found a table of exemplary catalyst compositions referenced hereinafter. The compositions in the table are not limited to the specific compounds found therein. More generally, the catalysts of the current disclosure may relate certain combinations of metals, and more specifically, the transition elements or transition metals, including the lanthanides and the actinides. Further, the transition series elements palladium, platinum, ruthenium, rhodium, gold, chromium, manganese, cobalt, nickel, and zinc are compatible with the disclosure herein. Additionally, the elements aluminum, silicon, tungsten, cerium, may be utilized in certain compositions. In still further alternative compositions, alloys of the elements listed herein before may be incorporated. More specifically, in certain configurations one or more of these transition elements may be utilized as a replacement for copper as described herein below. Additionally, one or more of the metallic elements described herein may be included into the support or other structures of the catalyst, in addition to elements or compositions not specifically listed.

Method:

The present disclosure includes a process for making catalysts comprising layered bricks. Further, the structure of such catalysts comprises one or more catalyst layers on top of each other, in any permutation and supported by a monolithic support or substrate. The layers and monolithic support collectively comprises a brick that may be of different lengths. Furthermore, the layers comprise different types and different compositions of catalytic metals and zeolites, as well as of thicknesses or loadings.

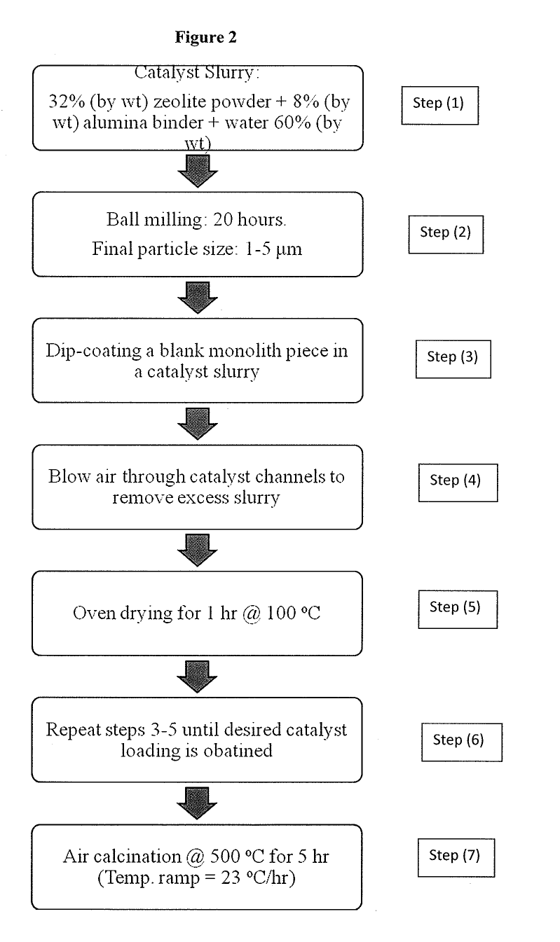

A non-limiting, exemplary process for making such layered catalysts is illustrated in FIG. 2. Generally the process relates to forming a catalyst slurry in step 1. The slurry is formed with water as a carrier for the other catalyst components.

In step 2, the slurry is ball milled from about 1 to about 30 hours; and alternatively for about 20 hours. Still further, the slurry is ball milled to produce a final particle size between about 0.1 μm and about 20 μm; alternatively to produce a final particle size between about 1 μm and about 5 μm.

Subsequently, in step 3 a blank monolithic support is dipped into the catalyst slurry. In instances, a monolithic support is a solid having a plurality of generally linear passages or circuitous passages extending axially therethrough. The monolithic support is in a class of structured supports, such as a ceramic support or a structured foam support that may include solids having a plurality of generally circuitous passages. Both the monolithic and foam supports may be made of ceramic or metallic materials. In certain instances, the monolithic support may be considered a “brick;” and alternatively, a brick precursor. Further, the channels may be considered gas passageways. The step of dipping may be considered forming a washcoat, or washcoating the support.

A gas is blown through the channels in step 4. The gas may be any inert gas, and alternatively, the gas may be air. The gas blown through the channels may remove any excess slurry. Further, blowing the gas throw the channels may at least partially facilitate an approximately even coating of the catalyst on the passage walls.

Step 5 in the exemplary method comprises oven drying the slurry coated brick or monolithic support. Generally, the drying step comprises a temperature of between about 50° C. and about 300° C.; and in certain instances, drying comprises a temperature of about 100° C. The drying step may be conducted for a period of between about 30 minutes and about 4 hours; and in certain instances, the drying step comprises a time of about an hour.

As disclosed herein the step 6 may comprise repeating the steps 3 through step 5. Additionally, the repeated steps may form subsequent layers of catalyst. The number of layers is operator or fabricator controlled, for example, by the number of repeats through those steps 3 through 5. Furthermore, the composition of such layers can be varied by changing the chemical composition of the catalyst slurry. More specifically, the composition of the catalyst slurry can be made of one of more catalytic metals with various elemental contents as described hereinabove, in addition to a zeolite powder, a binder such as alumina, and water as needed, for example incorporated into step 1. In addition to varying the composition of individual layers, the chemical structure of the catalyst itself and/or its content (weight percent; wt %), other parameters can be varied, including but not limited to the thickness and length of the individual layers. In certain instances, the monolithic structure may be partially dipped in catalyst slurry and thus, the final catalyst monolithic support may consist of two or more “bricks” or segments in an operator controlled axial sequence. Each brick or segment manufactured thusly may have a prescribed number of layers deposited on the walls of the channel or channels within the monolithic support or monolithic support piece. Furthermore, the composition of each layer may in turn consist of different amounts of metals contained within one or more zeolite(s). In certain additional instances, the mixture metals and zeolites may include added binder or other materials.

After step 6, the coated monolithic support having multilayer catalyst, multi-segment catalyst, or a combination thereof, may be calcined. Generally, the support is calcined in air at a temperature of between about 200° C. and about 700° C.; and in certain instances, at about 500° C. Further, the calcination may be for between about 1 hour and about 10 hours; and in certain applications for about 5 hrs. Additionally, the temperature ramp up/ramp down may be controlled, for example at between about 10° C. per hour and about 50° C. per hour. In certain instances, the temperature ramp may be between about 20° C. per hour and about 25° C. per hour, for example at about 23° C. per hour.

Baseline Configuration:

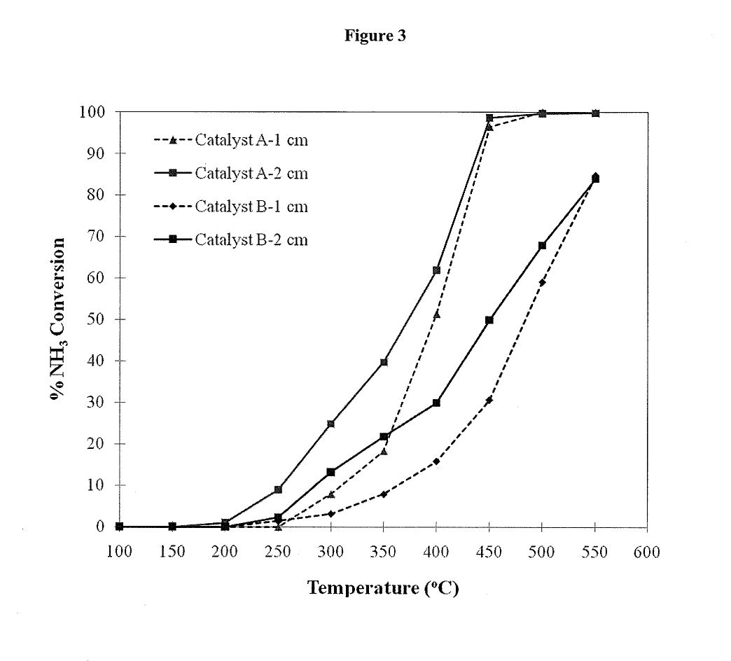

Commercial catalysts identified as Catalyst A and Catalyst B in FIG. 1, are used as points of reference with regard to conversion rates that can be currently achieved with known materials as a function of temperature for the catalytic reduction of NH₃ and NOx. In FIG. 3 there is illustrated the comparative results obtained for the oxidation of NH₃ using commercial catalysts made of either Cu-zeolite (Catalyst A) or Fe-Zeolite (Catalyst B) as a function of brick length or rather the catalyst coated segment length. Catalysts A and B each comprise a single catalytic layer on a monolithic substrate. These results indicate that the oxidation reaction of NH₃ starts at 250° C. and reaches complete NH₃ conversion at 450° C. for Catalyst A. Also, the results demonstrate that for temperatures up to 350° C., the longer the catalyst brick or segment length, the lower the temperature to achieve a prescribed NH₃ conversion. At temperatures lower than 400° C. and for a 1 cm-long catalyst brick, not enough catalyst material A is available (due to a shorter residence time of the flowing gas mixture) and hence the conversion is lower than that for the longer brick. For 2 cm-long catalysts, sufficient residence time (or amount of catalyst for the given flow rate) is available, which leads to higher NH₃ conversion for the same conditions.

Similar trends are observed with Fe-zeolite catalyst (Catalyst B) as shown in FIG. 3. However, with catalyst B, the conversion is found to be significantly lower for all temperatures compared to the Cu-zeolite catalyst (Catalyst A) and unlike Cu-zeolite, the conversion rate never reaches 100% at the temperatures and conditions utilized. Thus, the overall effect of the length of the catalyst on the conversion is similar to that obtained with Catalyst A, up to about 500° C. Above this temperature, the conversion is independent of the catalyst brick length.

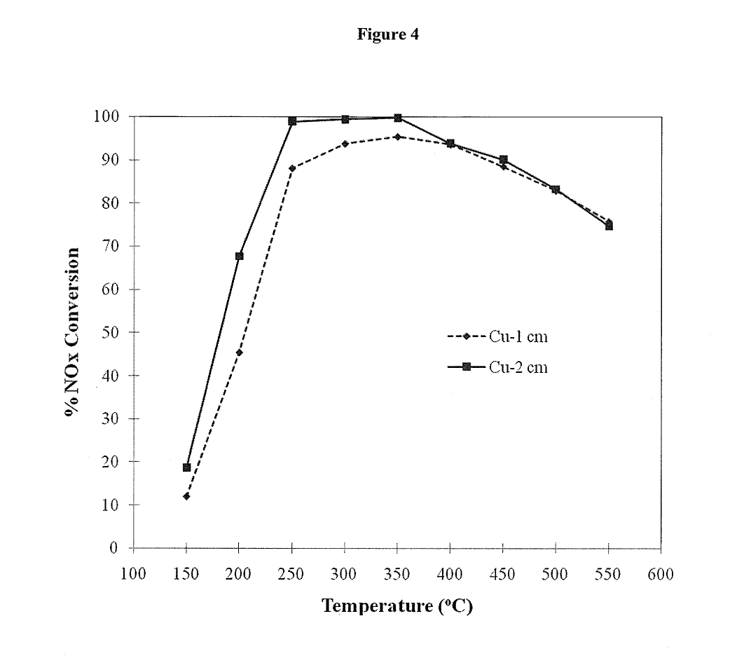

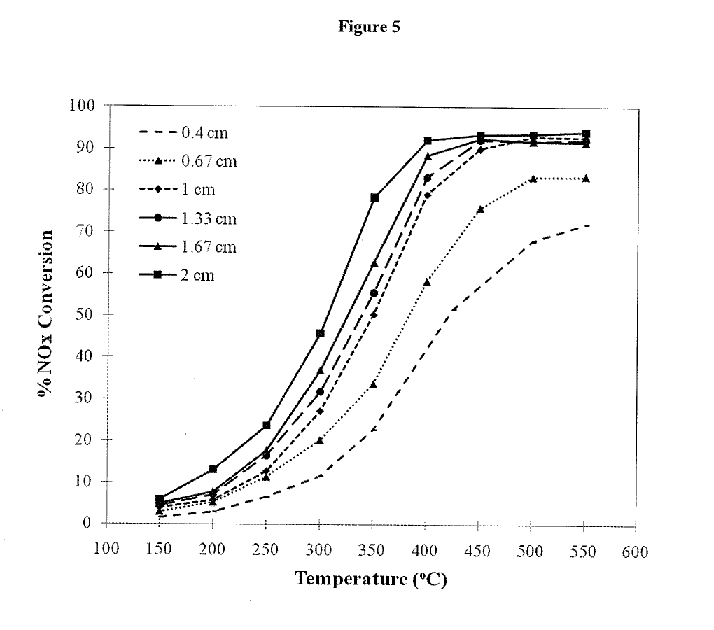

Referring now to FIG. 4, there is shown the comparative graphical results obtained for the conversion of NO (to N₂ or N₂O) by its reduction with NH₃ in the presence of O₂ as a function of brick length using a commercial catalysts made of either Cu-zeolite which is illustrated as Catalyst A shown in FIG. 4. Additionally, a Fe-zeolite graph is illustrated in FIG. 5, as Catalyst B. The same trend is observed as that observed with NH₃ oxidation reaction; that is, the longer the brick, the lower the temperature at which the catalytic reaction is taking place or achieves a prescribed conversion.

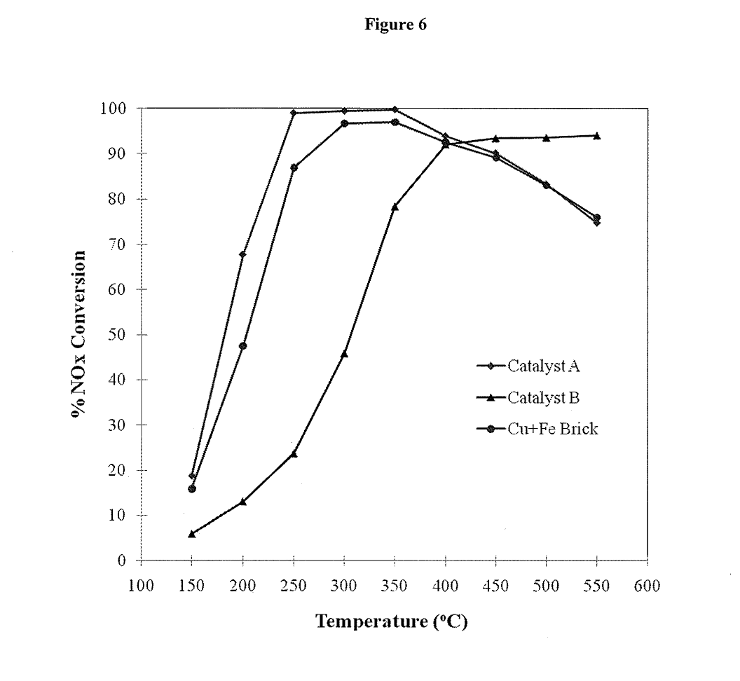

As such, in one configuration of the present disclosure, higher NO conversions are obtained with sequentially arranged catalysts such as illustrated in FIG. 6. FIG. 6 shows the conversion rate of NO during NO reduction by NH₃ as a function of temperature for Catalyst A (Cu) of 2 cm length and for Catalyst B (Fe) of 2 cm length. Thus, the Catalyst labeled “Cu+Fe Brick” is a non-limiting example of the catalyst composed of two segments, such as a segment of Catalyst A (Cu-zeolite) of 1 cm length followed by a segment of Catalyst B (Fe-zeolite) of 1 cm length, the overall axial length of the segments being 2 cm. The performance of this new segmented catalyst is similar to that obtained with Catalyst A in that they both display high NOx conversion at lower temperatures (<350° C.). The NOx reduction rates being higher on Cu-zeolite at lower temperatures, most of the NOx reduction activity takes place on the Cu-zeolite segment while the Fe-zeolite remained mostly unused under these conditions. Further, at higher temperatures, the NH₃ oxidation rates increase sharply, as shown in FIG. 3, and a large fraction of the NH₃ is consumed in the front 1 cm Cu-zeolite segment. Thus, the Fe-zeolite layer remains unused even at higher temperatures and such sequential segment or brick design wherein the Cu-zeolite brick is kept in the front does not offer a improvement in the NOx reduction activity at higher temperatures.

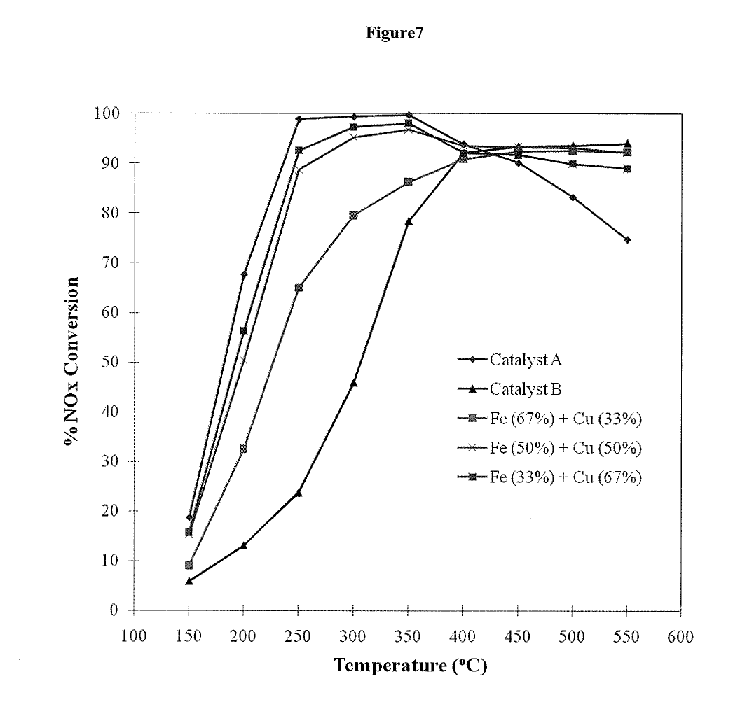

However, additional improvements may be obtained when the Cu-Zeolite layer is located behind the Fe-zeolite segment. Referring now to FIG. 7, which shows the conversion of NOx as a function of temperature using 2-segment catalysts where the Fe-zeolite segment or brick is located in front of the Cu-zeolite segment or brick and where the length of each catalyst, represented herein as a percent (%) of total length is varied while maintaining an overall length, for example in the present exemplary configurations, about 2 cm. In this configuration, the Fe-zeolite segment or brick first faces the incoming feed. Thus, at lower temperatures (≦350° C.), improved performance over the baseline configuration is obtained when the length of the Fe-zeolite brick or segment is relatively short (33%), while the Cu-zeolite brick or segment is longer (about 67%). The lower temperature (≦350° C.) NOx conversion approaches that of the 2 cm long Catalyst A segment when the Fe section is shorter than the Cu section. At higher temperatures (≧400° C.), the conversion of NO remains steady with temperature increases, and is generally better than that obtained with Catalyst A and similar to that obtained with Catalyst B only as in the conventional examples. Therefore, the sequentially positioned catalysts, as in that case made of two bricks or segments of two different catalysts, offer the benefits of retaining the performance of each of the individual catalysts and therefore may have performance benefits compared to any single monolithic layer.

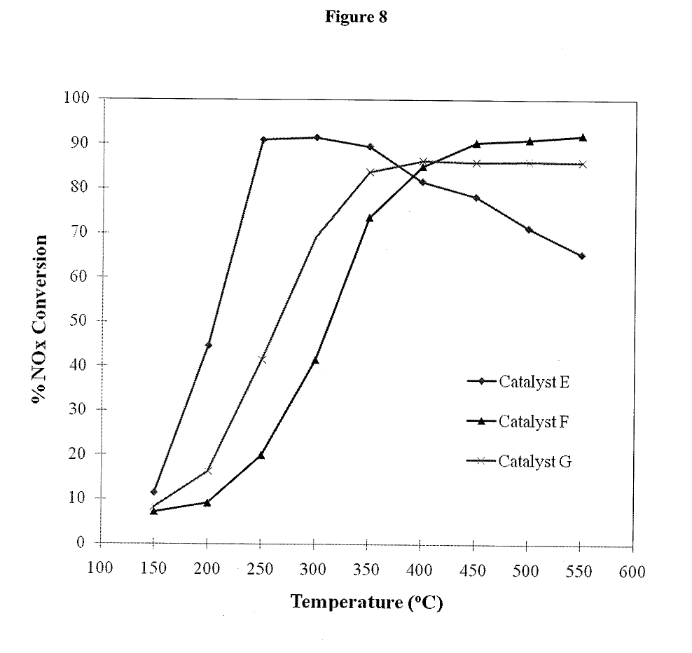

Another configuration of the present disclosure describes that higher NO conversion can also be obtained when the catalyst slurry, in non-limiting examples, step 1 of the exemplary process as described in FIG. 2, is composed of a chosen mixture of catalytic metals. More specifically, referring to FIG. 8 there is illustrated the comparative catalytic performance when only one catalytic metal is used in the catalytic slurry, such as either Catalyst E or Catalyst F from FIG. 1, and when a mixture of both, for example in equal amount, is used in the catalytic slurry. In this configuration, the washcoat loading for each catalyst is maintained constant at about 24 wt %, and wherein the washcoat loading refers to the percentage of the total mass of the catalyst that is present as the deposited layer or the deposited layers. Catalyst E has a single layer containing Cu-zeolite with a loading of about 24% while Catalyst F has a single layer containing Fe-zeolite with a loading of about 24%. Further, the graph in FIG. 8 illustrates that the accordingly mixed catalyst reveal NOx conversion at lower temperatures that is improved over the baseline techniques, but not in view of the Catalyst E only. Additionally, the mixed catalyst retains high conversion percentages at high temperatures. As such, it may be noted that the conversion percentages for Catalyst E decrease commensurate with the temperature decrease and thus may be undesirable in some applications.

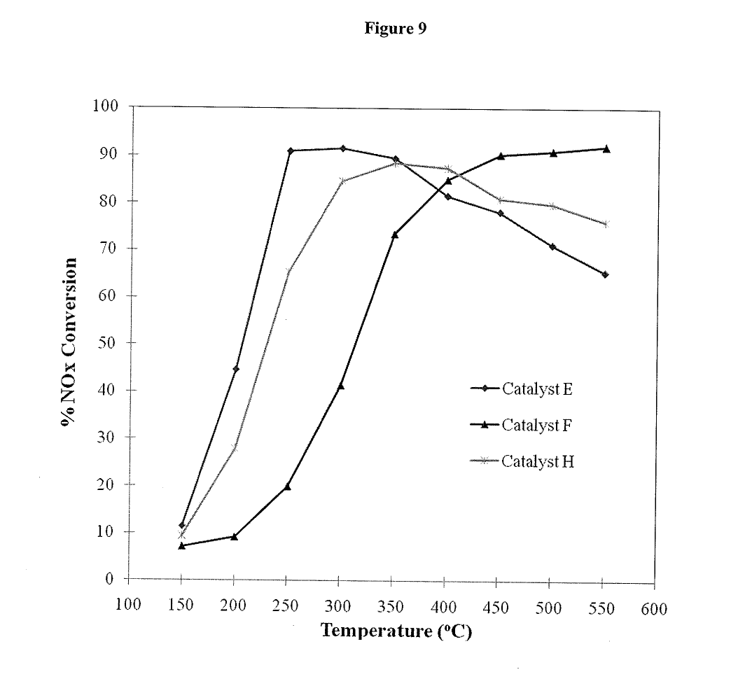

Referring now to FIG. 9, there is illustrated the comparative steady state NOx conversions. Further, FIG. 9 illustrates a synergetic effect of layered catalysts. More specifically, FIG. 9 illustrates NOx conversions obtained with Catalyst E only, Catalyst F only, and a layered catalyst made of Cu-zeolite on top of a Fe-zeolite. As describe herein with respect to FIG. 8, the total washcoat loadings are maintained at about 24 wt. %. The overall trend is that at low temperatures, the layered catalyst displays slightly lower performances compared to Catalyst E with significantly higher conversion performance than Catalyst F only, and an improved performance at high temperatures, but this lower conversion performance is obtained with Catalyst F only.

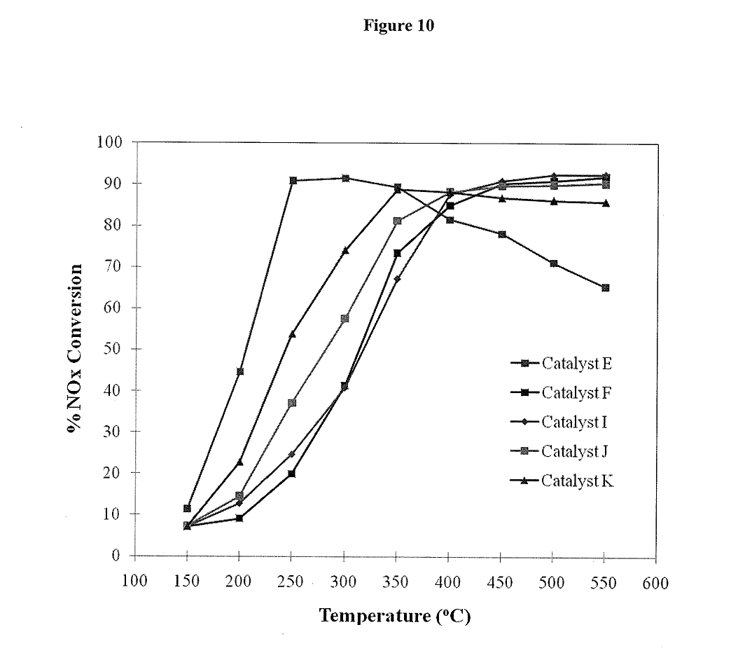

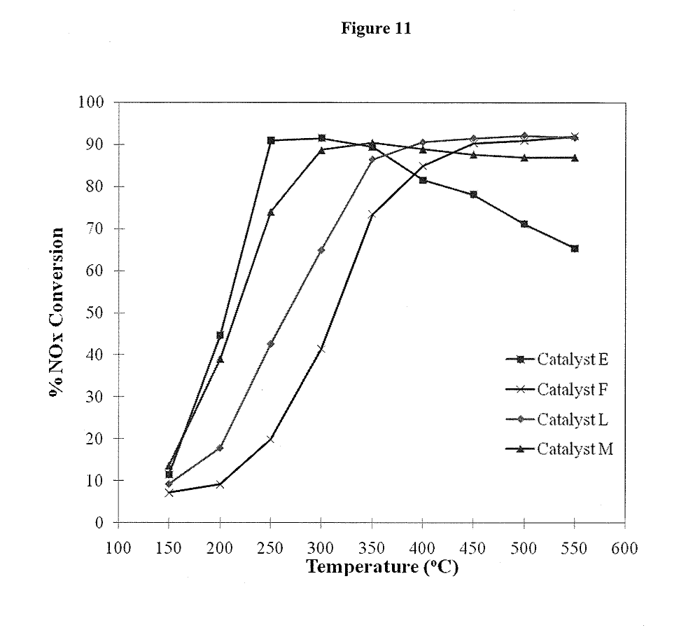

Another configuration of the present disclosure illustrates the effect of the nature and content of catalytic metal in the individual layers on the overall performance of layered catalysts for the reduction of NO/NO₂ (NOx) to N₂ as a function of temperature. In an example, the total washcoat loading of the catalysts, that is the summation of the content in each layer, is fixed at about 24% as described hereinabove. However, the layered system consists of a layer of Fe-zeolite on top of a Cu-zeolite. Thus for catalyst I as found in FIG. 1, the Fe-zeolite layer contributed about 67% of the total washcoat loading, or more specifically, about 16% of the total about 24% washcoat loading and is present in the top layer. Further, the Cu-zeolite contributed about 33%, as may be understood about 8% of the total washcoat loading of the original about 24%, and was present at the bottom. Thus, the content of the Catalyst I shown in FIG. 1 is about 16% Fe-zeolite layer and about 8% Cu-zeolite, to form a total of about 24%. Further, in Catalyst J, about 12% Fe-zeolite and about 12% Cu-zeolite, respectively, and in Catalyst K, about 8% Fe-zeolite and about 16% Cu-zeolite, respectively. The results shown in FIG. 9 display a similar synergistic effect of the layered system as previously described, in addition to a steady performance at about 90% as the temperature is increased above 350° C. Additionally, the graphs in FIG. 10 reveal that improved performance is obtained in the present configuration with a lower washcoat loading of the Fe-zeolite layer. Further configurations include a total content of the same layered catalyst, for example the layer of Fe-zeolite on top of a Cu-zeolite, may be fixed at about 30%. Similar trends are observed, compared to the results shown in FIG. 8, in terms of the conversion of NOx as a function of temperature. Moreover, the layered catalyst configurations as described herein above are able to sustain very high temperatures, for example over about 700° C. for several hours in an atmosphere containing a few percent H₂O. Once subjected to such conditions, the NOx conversion as a function of temperature, such as for example Catalysts L and M as illustrated in FIG. 11, remain similar, which demonstrates that the catalysts do not undergo substantial physical and/or chemical changes.

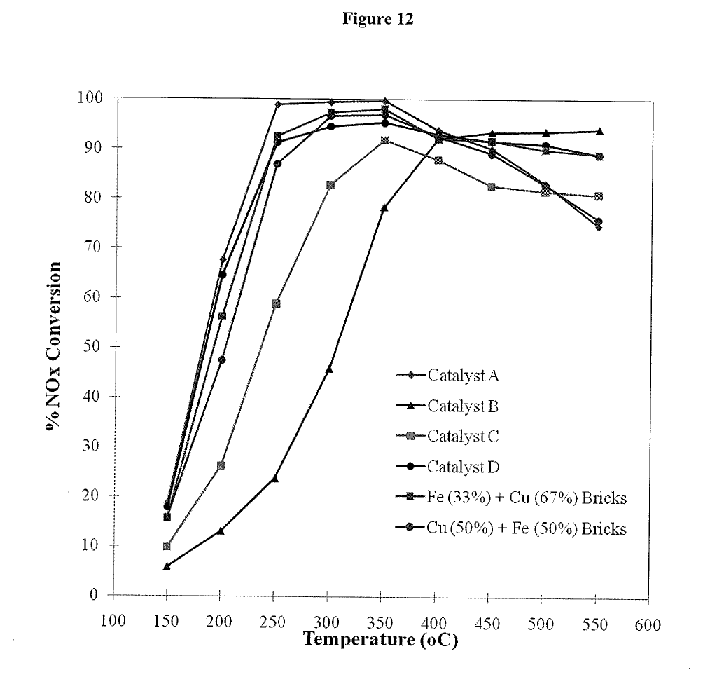

In a further configuration shown in FIG. 12, existing commercial catalyst formulations may be utilized in a novel configuration according to the present disclosure to provide an improved performance. More specifically, the Catalysts C and D in FIG. 1 may correspond to the commercial Catalysts B and A that are subsequently produced in a novel method with an about 12 wt % washcoat loading of Cu-ZSM-5 and Fe-ZSM-5, respectively. For comparison, two additional catalysts comprising two sequentially-positioned segments are shown; the “Fe33%)+Cu(67%)” sample has about the first one-third of the length consisting of Catalyst B (Fe-zeolite) and about the second two-thirds of the length consisting of Catalyst A (Cu-zeolite); the “Cu(50%)+Fe(50%)” sample has about the first one-half of the length consisting of Catalyst A (Cu-zeolite) and about the second one-half of the length consisting of Catalyst B (Fe-zeolite). An improved temperature range expansion that maintains a high NOx conversion may be found for example in either Catalyst D or Catalyst “Fe (33%)+Cu (67%)”.

In still another configuration of the present disclosure, the potential and potential use of dual-layer catalyst system for fast SCR reaction applications is illustrated. In the real exhaust aftertreatment system, the SCR unit is preceded by a diesel oxidation catalyst (DOC) unit, which may contain a precious metal like Pt, and has the role of catalyzing the oxidation of hydrocarbons, CO and NO. Thus, the reduction of NOx is enhanced significantly by NO₂ with the optimal feed ratio being NO/NO₂=1. The rate of SCR reaction increases in the presence of NO₂, especially at lower temperatures, on both the Fe- and Cu-zeolite catalysts. It is noted that the rate increment is more dramatic for Fe-zeolite compared to Cu-zeolite catalyst.

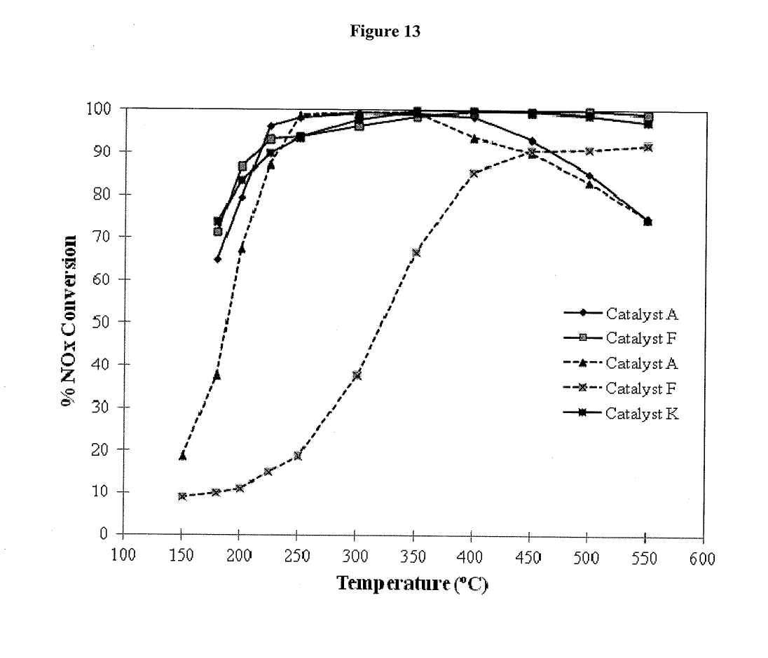

The results of NOx conversion obtained during the fast SCR reaction on both the Fe (i.e. catalyst F), the commercial Cu-zeolite (i.e. catalyst A), and also on catalyst K as an exemplary configuration of the dual layer catalyst system are shown in FIG. 13. In this non-limiting example, a feed containing an equimolar mixture of about 250 ppm each of NO and NO₂ was introduced in the presence of about 500 ppm NH₃, about 5% O₂ and about 2% water. The NOx conversions increase dramatically for the Fe-zeolite (i.e. catalyst F) catalyst especially at lower temperatures compared to the case of standard SCR reaction, as illustrated by dashed lines, and very high conversion of NOx was obtained at higher temperatures, for example above about 250° C. In the presence of feed NO₂, there was an enhancement in the NOx reduction activity at lower temperatures, even for the Cu-zeolite catalyst (A). However, as may be understood, the effect was not as dramatic as that for the Fe-zeolite. Further, the Cu-zeolite catalyst (A) exhibited similar trends in the NOx conversion at higher temperatures for both the standard and fast SCR reactions as described hereinabove. This includes the sharp decrease in the NOx conversion at temperatures above about 350° C. as a result of the consumption of the NH₃ reductant by oxidation. The dual layer catalyst K exhibited remarkably high NOx conversion, for example over about 90%, for the approximately the entire temperature range from about 200° C. to about 550° C. In instances, the NOx reduction activity of this catalyst was comparable to the Fe-only system even at higher temperatures where it showed very stable NOx reduction efficiency. Thus, a dual layer catalyst system with thinner Fe-zeolite layer on top of a thicker Cu-zeolite layer improves the NOx conversions, even for the case of fast SCR system representative of an actual diesel exhaust system, and according to the present disclosure.

At least one embodiment is disclosed and variations, combinations, and/or modifications of the embodiment(s) and/or features and/or characteristics of the embodiment(s) made by a person having ordinary skill in the art are within the scope of the disclosure. Alternative embodiments that result from combining, integrating, and/or omitting features and/or characteristics of the embodiment(s) are also within the scope of the disclosure. Where numerical ranges or limitations are expressly stated, such express ranges or limitations should be understood to include iterative ranges or limitations of like magnitude falling within the expressly stated ranges or limitations (e.g., from about 1 to about 10 includes, 2, 3, 4, etc.; greater than 0.10 includes 0.11, 0.12, 0.13, etc.). For example, whenever a numerical range with a lower limit, R₁, and an upper limit, Rᵤ, is disclosed, any number falling within the range is specifically disclosed. In particular, the following numbers within the range are specifically disclosed: R═R₁+k*(Rᵤ−R₁), wherein k is a variable ranging from 1 percent to 100 percent with a 1 percent increment, i.e., k is 1 percent, 2 percent, 3 percent, 4 percent, 5 percent, . . . 50 percent, 51 percent, 52 percent . . . 95 percent, 96 percent, 97 percent, 98 percent, 99 percent, or 100 percent. Moreover, any numerical range defined by two R numbers as defined in the above is also specifically disclosed. Use of broader terms such as comprises, includes, and having should be understood to provide support for narrower terms such as consisting of, consisting essentially of, and comprised substantially of. Accordingly, the scope of the disclosure is not limited by the examples and description set out above but is defined by the claims that follow, that scope including all equivalents of the subject matter of the claims. Each and every claim is incorporated as further disclosure into the specification and the claims are embodiment(s) of the present disclosure. The disclosure of all patents, patent applications, and publications cited in the disclosure are hereby incorporated by reference, to the extent that they provide exemplary, procedural or other details supplementary to the disclosure.

To further illustrate various illustrative examples of the present invention, the following examples are provided.

### EXAMPLES

Catalyst Preparation: Ion Exchange

The present examples used both the commercial and synthesized Fe- and Cu-zeolite monolithic catalysts. Commercial washcoated Cu-zeolite catalyst was supplied by BASF (BASF Catalyst division, Iselin, N.J.). Commercial washcoated Fe-zeolite (ZSM-5) catalyst were supplied by an unnamed catalyst supplier. Other washcoated catalysts were synthesized in-house using catalyst powder. Fe-zeolite (ZSM-5) powder was provided by SUD-CHEMIE (Munich, Germany). Cu-zeolite (ZSM-5) powder was synthesized by a conventional ion-exchange process described as follows:

The NH₄⁺ form of zeolite (NH₄-ZSM-5, SUD-CHEMIE, Munich, Germany) powder with a Si/Al ratio of 25 was used as the starting material. The NH₄-ZSM-5 powder was then calcined in a box furnace at about 500° C. for 5 hours to convert it into protonated form (H-ZSM-5). The H-ZSM-5 powder was ion-exchanged with about 0.1 M NaNO₃ solution by continuously stirring for several hours. The Na-ZSM-5 powder, thus obtained, was filtered and dried. This ion-exchange process was repeated twice. The Na-ZSM-5 powder was then ion-exchanged with about 0.02M copper acetate solution to give Cu-ZSM-5. The ion-exchange was then performed by continuous stirring of the solution for about 24 hours followed by filtration and drying. This step was repeated twice to get the final Cu-ZSM-5 powder which was then calcined for about 5 hours at about 500° C.

Catalyst Preparation: Monolith Washcoating

A dip-coating method of monolith washcoating to deposit catalyst powder on the blank monolith pieces was utilized. Blank cordierite monolith samples with cell density of about 400 cpsi and dimensions of about 1 inch diameter by about 3 inch length were supplied by BASF (Iselin, N.J.). Catalysts used in this study are summarized in FIG. 1.

The following is a brief description of synthesis of all the washcoated catalysts. In order to deposit a catalyst powder onto the monolith support, a catalyst slurry consisting of a mixture of zeolite powder, γ-alumina and water was prepared in the proportions about 32 wt. % zeolite, about 8 wt. % alumina, with the remainder water and a small amount of about 0.1N acetic acid to obtain a pH of about 3.5. Alumina served as a binder. The catalyst slurry was ball-milled for about 20 hours to obtain a uniform particle size of between about 1 μm and about 5 μm to get uniform washcoat layer. In order to deposit a Cu-zeolite layer on the commercial Fe-zeolite catalyst (Catalyst B), a slurry consisting of Cu-zeolite was prepared and CuZ-12 layer was deposited on it using the dip-coating technique. This catalyst was named as catalyst CAs, the CuZ-XX and FeZ-XX nomenclatures are used to define catalyst properties, such that -XX denotes the weight % of zeolite loading on the blank monolith support. The same slurry was used to synthesize all the CuZ-XX catalysts (e.g. catalysts E, H-M). In order to deposit Fe-zeolite layer on the commercial Cu-zeolite (e.g. catalyst A) catalyst, Fe-zeolite catalyst slurry was prepared. FeZ-12 layer was deposited on catalyst A by a dip-coating method. This catalyst was named as catalyst D as in FIG. 1. The same catalyst slurry was used to synthesize remaining FeZ-XX catalysts (e.g. Catalysts F, H-M). For catalyst H, first FeZ-12 layer was deposited on blank monolith support followed by the deposition of CuZ-13 layer. For the rest of the double layered catalysts (1-M), first CuZ-XX layer was deposited on the blank monolith support followed by the deposition of FeZ-XX layer above it. All the washcoated catalysts were then subjected to calcination at a very slow temperature ramp of about. 23° C./hr up to and maintained at about 500° C. for about 5 hours. The deliberate calcination reduced the likelihood of crack formation in the washcoat layer during operation

Bench-Scale Reactor Set-up

The experimental setup included a gas supply system, a reactor system, an analytical system and a data acquisition system. A monolith catalyst wrapped with a ceramic fiber was placed inside a quartz tube reactor mounted in a tube furnace. The furnace temperature was adjusted with a temperature controller. A FT-IR spectrometer (Thermo-Nicolet, Nexus 470) was placed downstream of the reactor to analyze various effluent gases including NH₃, NO, NO₂, N₂O and H₂O. A quadrupole mass spectrometer (QMS; MKS Spectra Products; Cirrus LM99) was used to measure N₂.

Steady-State Experiments

Several steady-state experiments were carried out on the catalysts described in FIG. 1. The experiments included NH₃ oxidation and standard SCR reaction. The gas hourly space velocity (GHSV; defined as the ratio of the volumetric flow rate per hour at standard conditions of pressure and temperature to the total geometric volume of the monolith sample) was kept constant at around 57,000 hr⁻¹ for most of the experiments. Ar was used as a balance gas and the total flow rate was maintained constant at 1000 sccm. Before the start of each experiment, each catalyst was pretreated with 5% O₂ in Ar at 500° C. temperature for 30 minutes. The catalyst temperature was then reduced down to the room temperature before the experiment was started. All the experiments were carried out in the temperature range of 150° C.-550° C. and sufficient time was given to reach the steady state effluent concentrations.

NH₃ oxidation reaction was studied on catalysts A and B using different dimensions of about 1 cm and about 2 cm catalyst lengths. The feed consisted of about 500 ppm NH₃, about 5% O₂, and about 2% water. Standard SCR reaction was studied on all the catalyst samples described in FIG. 13. For catalysts A and B, different lengths in the range of about 0.4 cm to about 2 cm were used to study this reaction. This helped in obtaining conversion data along the catalyst length. The feed consisted of about 500 ppm NO, about 500 ppm NH₃, about 5% O₂, and about 2% water for all the experiments. The fast SCR reaction (e.g. Equation 2) was studied on catalysts A, F and K. The feed consisted of about 250 ppm NO, about 250 ppm NO₂, about 500 ppm NH₃, about 5% O₂, and about 2% water for all the three cases.

The Examples disclosed herein relate to a novel class of catalytic materials for carrying out the selective catalytic reduction (SCR) of nitrogen oxides (NOx). One of ordinary skill in the art, with the benefit of this disclosure, would recognize the extension of the approach to other systems. Thus, the present disclosure is well adapted to attain the ends and goals described as well as those that are inherent therein. The particular configurations as disclosed above are illustrative only, as the present disclosure may be modified and practiced in different but equivalent manners apparent to those skilled in the art having the benefit of the teachings herein. Furthermore, no limitations are intended to the details of construction or design herein shown, other than as described in the claims below. It is therefore evident that the particular illustrative configurations disclosed above may be altered or modified and all such variations are considered within the scope and spirit of the present disclosure.

We claim:

1. A method of producing a catalyst, comprising
milling a catalyst slurry to form particles in the slurry smaller than about 20 microns;
washcoating a support with the catalyst slurry to form a coated support;
removing excess slurry from the coated support;
drying the coated support;
repeating the steps of washcoating, removing excess slurry, and drying the coated support to form a multi-layer catalyst; and
calcining the multi-layer catalyst,
wherein washcoating the support further comprises forming a plurality of catalyst composition segments.

2. The method of claim 1, wherein the catalyst slurry is milled to form particles smaller than about 5 microns.

3. The method of claim 1, wherein washcoating a support, further comprises at least partially dipping the support in the catalyst slurry.

4. The method of claim 3, wherein washcoating a support further comprises at least partially dipping the support in a plurality of catalyst slurries.

6. The method of claim 3, wherein washcoating a support further comprises dipping at least one axial portion of the support in a first catalyst slurry

7. The method of claim 6, wherein dipping at least one axial portion of the support in a first catalyst slurry comprises forming a first catalyst segment.

8. The method of claim 6, wherein dipping at least one axial portion of the support in a first catalyst slurry further comprises dipping at least the remaining axial portion of the support in a second catalyst slurry.

9. The method of claim 8, wherein forming a first catalyst segment further comprises dipping at least 25% of the axial length of the support in the first catalyst slurry.

10. The method of claim 9, wherein the first catalyst comprises at least 25% of the axial length of a first catalyst.

11. The method of claim 10, wherein the first catalyst comprises at least 33% of the axial length of a first catalyst.

12. The method of claim 11, wherein the first catalyst segment comprises at least one element chosen from the group consisting of palladium, platinum, ruthenium, rhodium, gold, chromium, manganese, cobalt, nickel, zinc, tungsten, cerium, copper, alloys thereof, and combinations thereof.

13. The method of claim 12, wherein the first catalyst segment comprises copper and a zeolitic material.

14. The method of claim 8, wherein the second axial slurry comprises iron and a zeolitic material.

15. The method of claim 1, wherein repeating the steps of washcoating, removing excess slurry, and drying the coated support to form a multi-layered catalyst further comprises controlling the concentration of a catalyst.

16. The method of claim 16, wherein controlling the concentration of a catalyst comprises forming a multi-layered catalyst having at least 25 wt. % catalyst.

17. A structure comprising:
a monolithic support or a structured foam support, both comprising ceramic or metallic materials, having:
at least one first catalyst segment; and
at least one second catalyst segment.

18. The structure of claim 17, wherein the monolithic support or the structured foam support has gas channels therethrough.

19. The structure of claim 17, wherein the at least one first catalytic segment comprises a plurality of layers of a first catalyst.

20. The structure of claim 19, wherein the plurality of layers of a first catalyst comprise at least one element chosen from the group consisting of palladium, platinum, ruthenium, rhodium, gold, chromium, manganese, cobalt, nickel, zinc, tungsten, cerium, copper, aluminum, alloys thereof, and combinations thereof.

21. The structure of claim 17, wherein the at least one second catalytic segment comprises a plurality of layers of a second catalyst.

22. The structure of claim 20, wherein the plurality of layers of a second catalyst comprise iron and a zeolitic material.

23. The structure of claim 17, wherein the first catalyst comprises at least 25% of the axial length of the monolithic support.

24. The structure of claim 17, wherein the first catalyst comprises at least 25% of the total layers of the catalyst deposited on the monolithic support.

25. A catalyst composition for selective catalytic reduction (SCR) of NOx, comprising
a monolithic support or structured foam support having channels therethrough;
a first catalytic segment having a first catalyst composition deposited on the support; and
a second catalytic segment having a second catalyst composition deposited on the support,
wherein the first catalyst composition is different than the second catalyst composition.

26. The catalyst composition of claim 25, wherein the first catalytic segment comprises at least one element chosen from the group consisting of palladium, platinum, ruthenium, rhodium, gold, chromium, manganese, cobalt, nickel, zinc, tungsten, cerium, copper, aluminum, alloys thereof, and combinations thereof.

27. The catalyst composition of claim 26, wherein the first catalytic segment comprises at least copper and a zeolitic material.

28. The catalyst composition of claim 25, wherein the second catalytic segment comprises at least iron and a zeolitic material.

29. The catalyst composition of claim 25, wherein the first catalytic segment and the second catalytic segment are axial segments of the monolithic support

30. The catalyst composition of claim 25, wherein the first catalytic segment and the second catalytic segment are layers on the monolithic support.
